(19) United States
(12) Patent Application Publication
(10) Pub. No.: US 2006/0060444 A1
(43) Pub. Date: Mar. 23, 2006

(54) Spiral spring applied torque-transmitting mechanism

(76) Inventors: Paul D. Stevenson, Ann Arbor, MI (US); Tejinder Singh, Canton, MI (US); Jeffrey J. Biallas, Dexter, MI (US)

Correspondence Address: LESLIE C. HODGES;General Motors Corporation, Legal Staff, Mail Code 482-C23-B21, P.O. Box 300, Detroit, MI, 48265-3000, US

(21) Appl. No.: 10/946,759

(22) Filed: Sep. 22, 2004

(51) Int. Cl. F16D 27/00

(52) U.S. Cl. 192/84.6

(57) ABSTRACT

A torque-transmitting mechanism includes a spiral spring, an apply piston, and a rotating mechanism. The rotating mechanism is operative to rotate a member relative to the spiral spring to enforce linear movement of the spiral spring which results in linear movement of the apply piston to enforce engagement and disengagement of a torque-transmitting mechanism. The mechanism has two applications—interconnecting two rotating members, or connecting a rotating member to a ground member. The mechanism is employable in two systems. A motor drives the spiral spring with the rotation of the spring causing it to thread between stationary pins to move spring material to one side of the pins. The spiral spring pushes against the clutch plates. The motor drives the housing with pins and the spring is retained from rotating causing the spring to thread through the pins and drive the pins forward or backward. The housing presses against the clutch plates.

### TECHNICAL FIELD

This invention relates to torque-transmitting mechanisms and, more particularly, to electromechanical apply systems for torque-transmitting mechanisms.

### BACKGROUND OF THE INVENTION

Automotive automatically shifted transmissions generally require a plurality of torque-transmitting mechanisms that are selectively operable to effect interchange between transmission ratios as well as maintaining the transmission ratio. The torque-transmitting mechanisms are either rotating type, commonly termed clutches, or stationary type, commonly termed brakes. These devices are hydraulically applied to an axially movable piston. The hydraulic pressure, which is utilized to apply the torque-transmitting mechanism, is supplied through an electro-hydraulic control mechanism, which includes a plurality of valve members as well as a plurality of pressure control members. This requires a large amount of fluid to be moved at high pressures through fairly narrow and constricted or tortuous paths.

The complexity of the hydraulic system requires a significant expenditure of capital to ensure that the transmission control system operates properly over a long period of time. One of the more important aspects of this control system and the efficiency thereof is the sealing of the hydraulic fluid to reduce the amount of leakage, which might otherwise occur within the system.

### SUMMARY OF THE INVENTION

It is an object of the present invention to provide electro-mechanically applied torque-transmitting mechanisms for use in a planetary type multi-speed automatic shifting power transmission.

In one aspect of the present invention, a spiral spring and a torque-transmitting apply member are operatively connected to provide linear motion of the apply member during the engagement of a torque-transmitting mechanism.

In another aspect of the present invention, at least one portion of the apply mechanism is rotated by an electric motor which results in the axial progression of the apply piston toward the engagement condition of the torque-transmitting mechanism.

In yet another aspect of the present invention, the rotating apply mechanism is operatively connected with the spiral spring which is interwoven with the apply piston such that rotation of the spiral spring results in linear translation of the apply piston.

In yet still another aspect of the present invention, a plurality of rollers are disposed in a housing between adjacent coils of the spiral spring and the housing is rotated by a rotating mechanism to enforce linear motion of the spiral spring and the apply piston of the torque-transmitting mechanism.

With the present invention, the torque-transmitting mechanisms are mechanically applied through the linear actuation of an apply piston and the linear motion of a spiral spring. The apply mechanism consists of an electric motor and therefore does not have a need for high-pressure fluid to actuate the apply piston. The fluid system of the transmission therefore only needs to supply lubrication and cooling flow to the various components of the transmission such as the friction plates, gear mechanisms, and bearings. This greatly reduces the assembly and manufacturing costs of the transmission.

### DESCRIPTION OF THE DRAWINGS

FIG. 1 is a cross-sectional elevational view of a portion of a power transmission incorporating the present invention.

FIG. 2 is an enlarged view of a portion of the engagement mechanism for a torque-transmitting mechanism shown in FIG. 1.

FIG. 3 is an alternative embodiment of an apply mechanism for a torque-transmitting mechanism.

FIG. 4 is an alternative embodiment of the drive mechanism shown in FIG. 3.

FIG. 5 is an unwrapped view taken along line 5-5 of FIG. 3.

### DESCRIPTION OF THE EXEMPLARY EMBODIMENTS

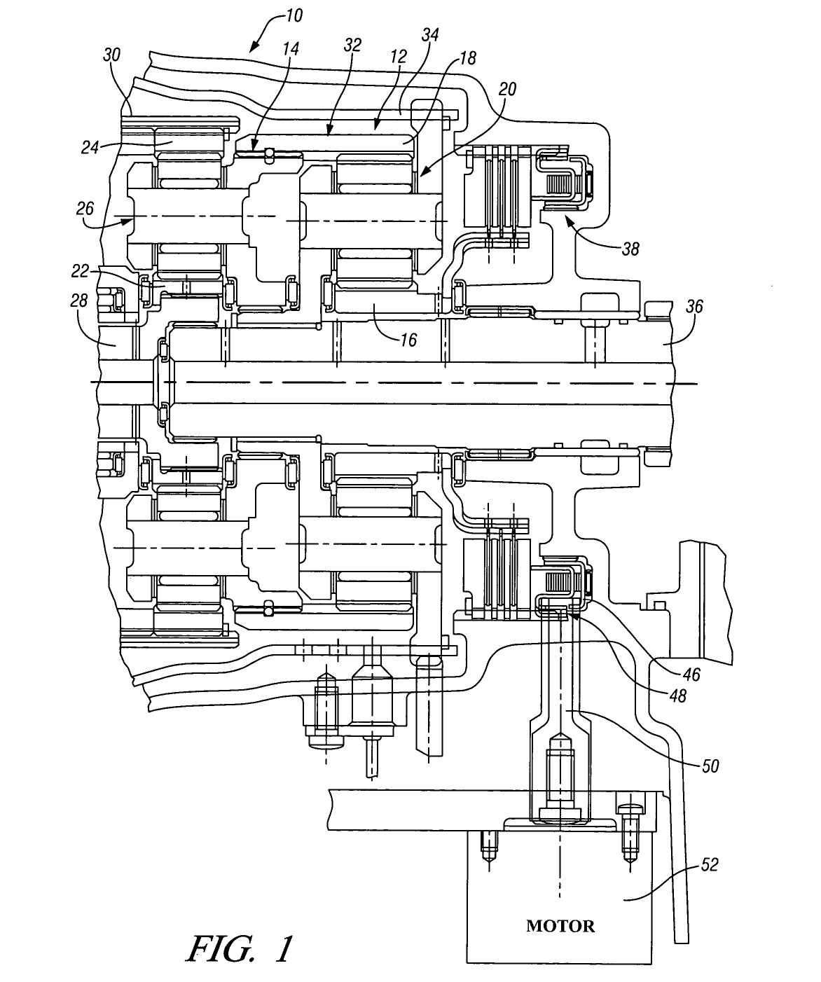

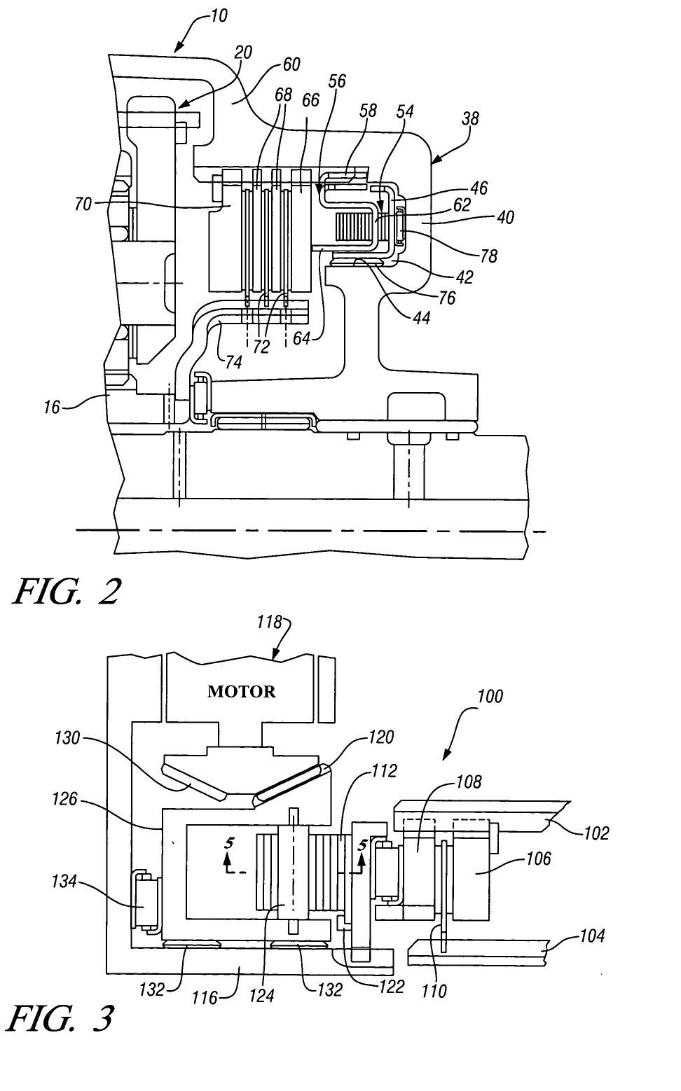

Referring to the drawings, wherein like characters represent the same or corresponding parts throughout the several views, there is seen in FIGS. 1 and 2 a power transmission generally designated 10, which incorporates a plurality of planetary gear mechanisms 12 and 14. The planetary gear mechanism 12 includes a sun gear member 16, a ring gear member 18, and a planet carrier assembly member 20. The planetary gearset 14 includes a sun gear member 22, a ring gear member 24, and a planet carrier assembly member 26.

The sun gear member 22 is drivingly connected with a shaft 28, which might represent the input shaft to a transmission. The ring gear member 24 is connected with a hub 30, which might be connected to a torque-transmitting mechanism, not shown. The ring gear member 18 and planet carrier assembly member 26 are interconnected through a hub portion 32. The planet carrier assembly member 20 is connected with a hub 34, which might be connected also to a torque-transmitting mechanism, not shown. The planet carrier assembly member 20 is also connected with a transmission output shaft 36. The sun gear member 16 is operatively connected with a stationary torque-transmitting mechanism 38.

As best seen in FIG. 2, the torque-transmitting mechanism 38 includes a housing portion 40 in which is formed a cavity 42. The cavity 42 has a circumferential wall 44 that rotatably supports a gear housing 46. As seen in FIG. 1, the gear housing 46 is drivingly connected to a gear member 48, which in turn is rotatably driven by a shaft 50, which is operatively or drivingly connected with an electric motor 52.

A spiral spring 54 is secured to the gear housing 46 and rotates therewith. An apply piston 56 has an outer circumferential portion 58, which is splined to a transmission housing 60. The piston 56 also has a central radially extending portion 62 and an inner circumferential and axially extending portion 64. The radial portion 62 passes between adjacent coils of the spiral spring 54. The inner axial portion 64 is disposed to abut a pressure plate or friction plate 66.

The torque transmitting mechanism 38 also includes a pressure plate 66 a plurality of friction plates 68 and a backing plate 70 all of which are splined to the housing 60. The pressure plate 66, friction plates 68, and backing plate 70 are alternately spaced with a plurality of friction plates 72, which are splined to a hub 74. The hub 74 is drivingly connected with the sun gear member 16. As is well known, with torque-transmitting mechanisms, one of the sets of friction plates, for example 72, are lined with a friction material, while the other plates 66, 68, and 70 are plain steel plates. The plates 66, 68, 70 and the plates 72 combine to form a “clutch pack” or “friction pack” that is a conventional structure well known in the art.

The electric motor 52 is controlled by a conventional electronic control system, which may include a preprogrammed digital computer, not shown. When it is desired to operate the torque-transmitting mechanism 38, the electric motor 52 is rotated thereby causing rotation of the gear housing 46. The gear housing 46 is supported on a bushing 76, and supported in a thrust direction by a thrust needle bearing 78.

As the gear housing 46 rotates, the spiral spring 54 will also rotate, such that the apply piston 56 will be moved axially between adjacent coils of the spiral spring resulting in enforcement of frictional engagement between the plates 66, 68, 70, and the friction plates 72. To enforce disengagement of the torque-transmitting mechanism 38, the electric motor 52 is rotated in the opposite direction thereby causing the apply piston 56 to translate rightward, as seen in FIG. 2. Thus, the engagement and disengagement of the torque-transmitting mechanism 38 is controlled by the linear translation of the apply piston 56, which is induced by the rotation of the spiral spring 54 relative thereto. The torque-transmitting mechanism 38 is a stationary type torque-transmitting mechanism, which holds the sun gear member 16 stationary when the torque-transmitting mechanism 38 is engaged.

In FIG. 3, a rotating type torque-transmitting mechanism 100 is shown. The torque-transmitting mechanism 100 includes a first clutch housing 102 and a second clutch housing 104. The clutch housing 102 is splined to a plurality of friction plates 106, 108, and the housing 104 is splined to a friction plate 110, which is disposed between the plates 106 and 108.

The torque-transmitting mechanism 100 depicts only three friction plates for simplicity of description; however, a plurality of plates might be splined to the housing 102 and a like number of plates 110 would be splined to the housing 104. Both of the housings 102 and 104 are permitted to rotate such that the torque-transmitting mechanism 100 is a rotating-type torque-transmitting mechanism, commonly termed a clutch.

Further components of the torque-transmitting mechanism 100 include an apply piston 112, which is separated from the plate 108 by a roller thrust bearing 114. The apply piston 112 is splined to a stationary housing 116, which also supports an electric motor 118.

A spiral spring 120 is drivingly connected to a tab 122 on the apply piston 112. Thus, the end of the spring 120 is stationary relative to the piston 112. A plurality of rollers 124, as best seen in FIG. 5, is disposed between adjacent coils of the spiral spring 120. The rollers 124 are supported in a rotatable housing 126, which has a bevel gear portion 128 meshing with a bevel gear 130. The bevel gear 130 is rotatably driven by the electric motor 118.

The housing 126 is supported on a pair of bushings 132 and is also supported by a roller thrust bearing 134. Thus, the housing 126 is rotatably supported on and rotates relative to the housing 116. As the rollers 124 are driven in a rotational sense, as best seen in FIG. 5, the coils of the spiral spring 120 will advance either in the direction of Arrow A or in the direction of Arrow B, depending upon the direction of rotation of the housing 126.

If the spiral spring 120 advances in the direction of Arrow A, the apply piston 112 will advance in the direction of Arrow C, as shown in FIG. 3, resulting in the engagement of the friction plates 106, 108, and 110, thereby enforcing co-rotation between the housings 102 and 104. If the spiral spring 120 advances in the direction of Arrow B, the apply piston 112 will be moved axially away from the engagement position, thereby disengaging the torque-transmitting mechanism 100.

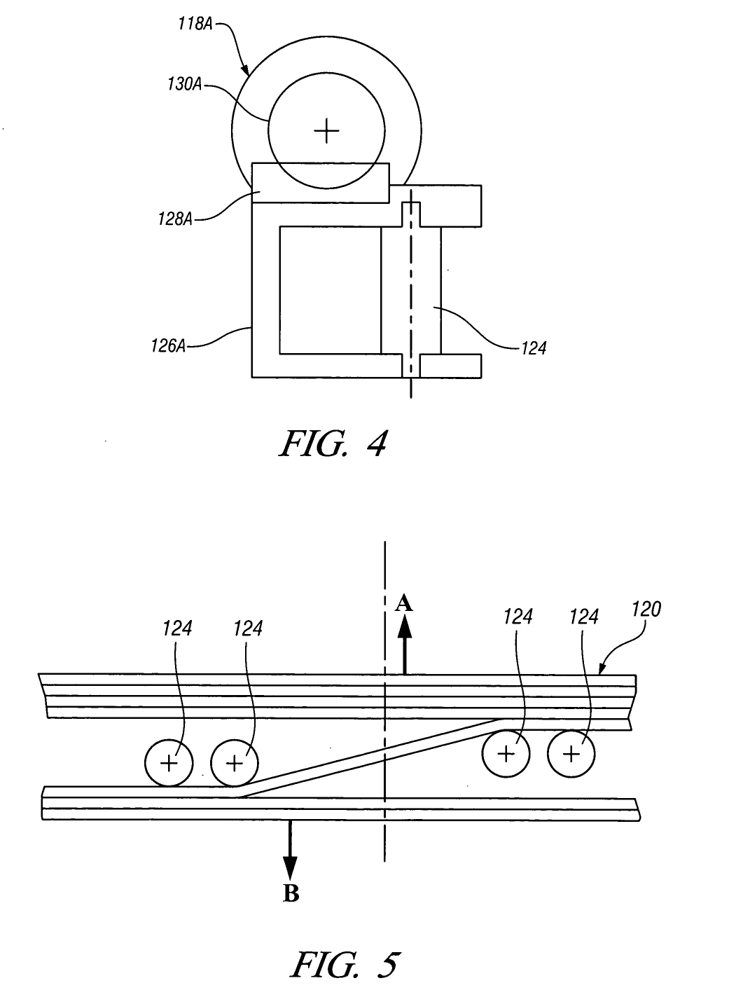

FIG. 4 represents an alternative embodiment of the rotating drive mechanism. The rotating drive mechanism in FIG. 4 includes an electric motors 118A and a worm gear 130A. The worm gear 130A drives another worm gear 128A, which in turn enforces rotation of a housing 126A. The rollers 124 are disposed in the housing 126A in a manner similar to that shown in housing 126. Again, as the housing 126A is rotated, the rollers 124 will progress between the coils of the spiral spring 120, thereby enforcing linear actuation of the apply piston 112. The type of drive mechanism utilized, that is an electric motor and gear system, is a designer's choice and will vary from transmission to transmission depending upon the type of torque-transmitting mechanism employed and the space available for the drive mechanism.

From the above teaching, those skilled in the art will recognize that the mechanism is employable in two systems. A motor drives the spiral spring with the rotation of the spring causing it to thread between stationary pins to move spring material to one side of the pins. The spiral spring pushes against the clutch plates. The motor drives the housing with pins and the spring is retained from rotating causing the spring to thread through the pins and drive the pins forward or backward. The housing presses against the clutch plates.

1. A torque-transmitting mechanism comprising:
an input member;
an output member;
a first friction plate means drivingly connected with said input member;
a second friction plate means drivingly connected with said output member;
an apply piston means for enforcing frictional engagement of said first and second friction plate means to establish torque transmission between said input member and said output member;
a spiral spring operatively connected with said apply piston means; and
rotating means operatively connected with said spiral spring means to develop relative linear movement between said rotating means and at least one of said apply piston means and said spiral spring means to enforce engagement of said torque-transmitting mechanism.

2. The torque-transmitting mechanism defined in claim 1 further comprising:
said means for rotating including roller means disposed between adjacent coils of said spiral spring, and drive means for enforcing rotation of said roller means to cause relative linear movement between said roller means and said spiral spring.

3. The torque-transmitting mechanism defined in claim 1 further comprising:
said apply piston means having a radial portion disposed between adjacent coils of said spiral spring, and said rotating means being operative to rotate said spiral spring means relative to said apply piston means to enforce relative linear movement therebetween.

4. A torque-transmitting mechanism comprising:
an input member;
an output member;
a first friction plate means drivingly connected with said input member;
a second friction plate means drivingly connected with said output member;
an apply piston means for enforcing frictional engagement of said first and second friction plate means to establish torque transmission between said input member and said output member;
a spiral spring operatively connected to said apply piston means; and
means for rotating one of said apply piston means and said spiral spring means to enforce linear movement of said apply piston means to engage said torque-transmitting mechanism.

5. The torque-transmitting mechanism defined in claim 4 further comprising:
a stationary housing;
said output member being continuously connected with said stationary housing.

6. The torque-transmitting mechanism defined in claim 4 further comprising:
said means for rotating including roller means disposed between adjacent coils of said spiral spring, and drive means for enforcing rotation of said roller means to cause relative linear movement between said roller means and said spiral spring.

7. The torque-transmitting mechanism defined in claim 4 further comprising:
a stationary housing;
said spring being continuously connected with said stationary housing.

8. The torque-transmitting mechanism defined in claim 4 further comprising:
a first rotatable member connected with said input member;
a second rotatable connected with a rotatable member; and
said spring being continuously connected with one of said rotatable members.
